(19) United States
(12) Patent Application Publication
(10) Pub. No.: US 2023/0241785 A1
(43) Pub. Date: Aug. 3, 2023

(54) ROBOTIC ARM GRABBING DEVICE

(71) Applicant: Christopher Harrigan, Greer, SC (US)

(72) Inventor: Christopher Harrigan, Greer, SC (US)

(21) Appl. No.: 18/105,693

(22) Filed: Feb. 3, 2023

Related U.S. Application Data
(60) Provisional application No. 63/306,448, filed on Feb. 3, 2022.
(60) Provisional application No. 63/306,894, filed on Feb. 4, 2022.

(51) Int. Cl. B25J 15/00; B25J 9/16

(52) U.S. Cl. CPC B25J 15/0033; B25J 15/0028; B25J 9/1653; B25J 9/1697

(57) ABSTRACT

The invention is a device for grabbing an item. Specifically, the device comprises an arm that can be moved relative to a base and an array of pins configured to extend a length away from the base to contact the item to be grabbed. Once the pins contact the item to be grabbed, they cease extending away from the base. At least one axis of movement for the item is controlled by the device. More than one pin is configured to extend further than a minimum axis to contact the item.

### CROSS REFERENCE TO RELATED APPLICATIONS

The present application claims the benefit of U.S. Provisional Patent Application Nos. 63/306,448 and 63/306,894, filed Feb. 3, 2022, and Feb. 4, 2023, respectively, the entire content of which are incorporated by reference herein.

### TECHNICAL FIELD

The presently disclosed subject matter is directed to a robotic arm grabbing device and to methods of making and the using the same.

### BACKGROUND

There is currently a large push among tech and supply chain companies to automate the distribution centers utilized by companies like Amazon® and Walmart®. Currently, no current design has yet mastered the art of successfully selecting an item and dropping the selected item into a bin with a sufficiently high degree of accuracy and reliability. If such a feat can be achieved, it will be the final piece in the puzzle to largely automate many distribution centers.

There are currently several different options conventionally used for grasping items. First, traditional pincer designs are similar to the well-known toy machine where a claw attached to a crane grasps a desired item. The design can two or more pincers. However, these designs rely on very sophisticated spatial analysis hardware/software, and have a difficult time grabbing items in a messy pile or in tight spaces. In addition, the design has difficulty grasping oddly shaped items (e.g., items that are not conventionally square or rectangular).

Suction grabbers are also well known and rely on an ultra-flexible nozzle tip that exerts a vacuum force on a desired item after the nozzle contacts and presses against the item. However, suction grabbers can only grab items with a surface sufficiently smooth to allow the nozzle tip to create a vacuum when it contacts the item. It also requires very sophisticated spatial analysis hardware/software.

Further, octopus grabbers rely on an inflatable (e.g., octopus tentacle shaped) pincer that can flexibly modify its change its shape to grab an item. However, the total grabbing force can be limited in the octopus grabber design. In addition, the design has difficulty reaching tight spaces and is limited in the number of differing item shapes it can pick up.

It would therefore be beneficial to provide a grabbing device that overcomes the shortcomings of the prior art.

### SUMMARY

In some embodiments, the presently disclosed subject matter is directed to a device comprising multiple pins that exert a physical force to grab an item. The physical force can be pressure, suction, or combinations thereof.

In some embodiments, the presently disclosed subject matter is directed to a device for grabbing an item. Specifically, the device comprises an arm that can be moved relative to a base. The base comprises an array of pins configured to extend a length away from the base to contact the item to be grabbed. Once the pins contact the item to be grabbed, they cease extending away from the base. At least one axis of movement for the item is controlled by the device. More than one pin is configured to extend further than a minimum axis to contact the item.

In some embodiments, the device includes at least 2 pins.

In some embodiments, the device includes about 15-200 pins.

In some embodiments, the pins are flexible.

In some embodiments, all of the pins are parallel relative to each other.

In some embodiments, at least one pin is angled relative to at least one other pin.

In some embodiments, the pins are configured to move toward and away from the item to be grabbed.

In some embodiments, each pin is configured to press, bend, curve, or combinations thereof in one or more directions.

In some embodiments, the arm, base or both the arm and base are configured to move toward or away from the item to be grabbed while the pins remain stationary.

In some embodiments, the device is configured to locate the item by measuring a depth of at least one pin to create a 3D field and analyzing a depth measure using hardware or software.

In some embodiments, the device is configured to use a database of information related to size, shape, and weight of the item to be picked up to allow the device to find and grasp the item.

In some embodiments, the device includes an end cap that allows an attached sole to rotate around an axis, thereby providing a gripping force.

In some embodiments, the sole comprise foam or a sponge comprising compression that provides grabbing force and a gripping force.

In some embodiments, a larger arch provides more gripping force per angle of rotation, and a smaller arch provides less gripping force per angle of rotation.

In some embodiments, the presently disclosed subject matter is directed to a method of grabbing an item. Specifically, the method comprises positioning the disclosed device adjacent to an item to be grasped. The method includes extending one or more pins toward the item until they contact the item, such that a mechanical force is exerted on the device, whereby friction is used to grab the item.

In some embodiments, friction and contact by one or more angled pins are used to grab the item.

In some embodiments, the one or more pins bend around an exterior of the item.

In some embodiments, the bendable pins include memory metal.

In some embodiments, the one or more angled pins slide under or behind the item and apply a force on the item.

In some embodiments, two devices are positioned on either side of an item to be grabbed, such that the pins on each device contact the item.

### BRIEF DESCRIPTION OF THE DRAWINGS

FIG. 1 is a perspective view of a pin screen toy in some embodiments.

FIG. 2 is a cross-sectional view of an item being contacted by a plurality of pins in accordance with some embodiments of the presently disclosed subject matter.

FIG. 3 is a cross-sectional view of an item with a pin positioned on each side in accordance with some embodiments of the presently disclosed subject matter.

FIG. 4 is a cross-sectional view of an item with an angled pin positioned below the item in accordance with some embodiments of the presently disclosed subject matter.

FIG. 5 is a cross-sectional view of a item with curved pins on either side thereof in accordance with some embodiments of the presently disclosed subject matter.

FIG. 6 is a top plan view of the pins of a grabbing device in accordance with some embodiments of the presently disclosed subject matter.

FIG. 7 is a front plan view of a pair of robotic arms grabbing devices grabbing an item in accordance with some embodiments of the presently disclosed subject matter.

FIG. 8 is a front plan view of an automatic gripping system in accordance with some embodiments of the presently disclosed subject matter.

FIG. 9 is a front plan view of an automatic gripping system in accordance with some embodiments of the presently disclosed subject matter.

FIG. 10 is a front plan view of a gripping device in use on a steep slope without a sole in accordance with some embodiments of the presently disclosed subject matter.

FIG. 11 is a front plan view of a gripping device in use on a steep slope with a sole in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments+/−20%, in some embodiments+/−10%, in some embodiments+/−5%, in some embodiments+/−1%, in some embodiments+/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

As set forth in detail below, the disclosed Kilo-Pin grabbing device can easily and efficiently be used to grab a variety of items of various shapes and sizes. It should be appreciated that items human hands have issues with (such as a tightly packed box of uniform boxes) are best picked up by the suction method. Thus, having a suction device on hand as a second method of grabbing an item may be beneficial.

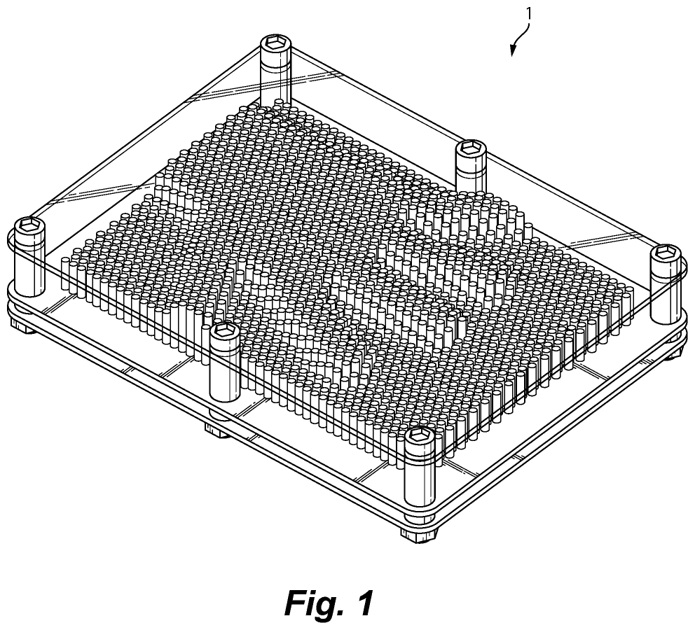

The disclosed grabbing design is loosely based on a similar basic concept to the popular pin screen toy 1 shown in FIG. 1. From Wikipedia: “Pin Art or Pinscreen is an executive toy patented in 1987 by Ward Fleming. It consists of a boxed surface made of a crowded array of pins that are free to slide in and out independently in a screen to create a three-dimensional relief. Other similar product names are “PinPressions” and “Pinhead”. The original Pinscreen toys were made of metal pins, which were heavier and tended to bend easily; newer Pinscreen toys are generally made of plastic pins. Pinscreens have also been used for animation production; a larger device working on a similar principle was invented by Claire Parker in 1935.”

The grabbing device can include any number of pins 15 (e.g., 2 or more). For example, the device can include at least about (or no more than about) 2, 5, 10, 50, 100, 150, 200, 250, 300, 350, 400, 450, 500, or more pins. Each pin can include any cross-sectional shape (such as circular, oval, square, triangular, rectangular, and the like). The pins can be constructed from any desired material (e.g., plastic, metal, wood) and be configured in any shape. In some embodiments, pins can be flexible (e.g., able to change shape and bend). In some embodiments, multiple devices can be used simultaneously to grab an item. For example, two Kilo-Pin devices can be configured to face each other and move like traditional pincers.

In some embodiments, pins 15 are all parallel relative to each other. However, the disclosed Kilo-Pin device can also include embodiments where one or more pins are angled relative to one or more other pins (e.g., some pins can be parallel while other pins are angled). The term “angled” means non-parallel and can include an angle of at least about (or no more than about) 5, 10, 15, 20, 25, 30, 35, 40, 45, 50, 55, 60, 65, 70, 75, 80, 90, 95, 100, 105, 110, 115, 120, 125, 130, 135, 140, 145, 150, 155, 160, 165, 170, 175, or 180 degrees.

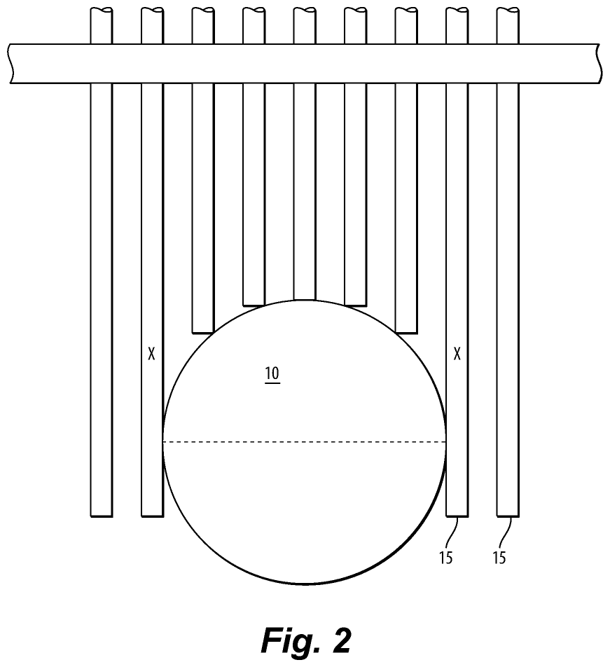

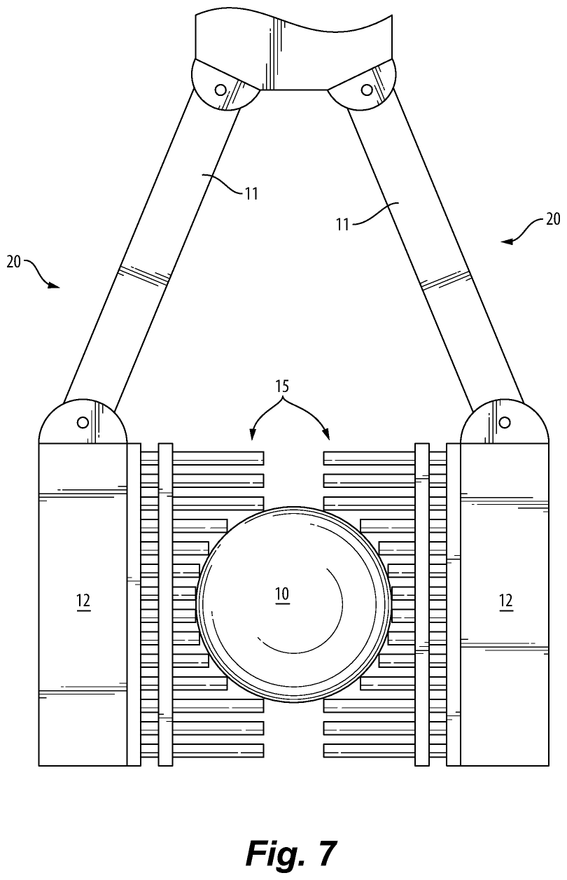

In use, the Kilo-Pin device moves an array of pins towards an item to be grasped. Once close, the pins extend until the necessary length of extension is reached to be able to grab the item without applying too much force to cause damage to the item. The Kilo-Pin device can also move rearward relative to the item to be picked up, while the pins stay stationary, or any combination of movements between the device and the individual pins both relative to each other and the item to be picked up. Thus, the pins and/or device can move to ensure that enough pins are close enough in depth relative to the item to be picked up, allowing at least one pin to contact the item. Once this step is achieved, at least one axis of movement for the item is controlled by the Kilo-Pin device. Additionally, a 3d field can be generated, letting the machine know where the item to be grabbed is located relative to the Kilo-Pin device by measuring the depth of at least one pin and analyzing that information with hardware/software. The overall system can use a database of all of the information related to size, shape, and weight of the items to be picked up. The data can be referenced to help find and grasp the item. The key for this to work is that more than one pin needs to have extended further than the minimum axis to be able to grab the item in single kilo-pin grabber designs. An example is shown in FIG. 2. In FIG. 2, pins marked with an X have extended far enough. Diagram 2 is a limited cross section of one row of pins in the Kilo-Pin device and a typical item 10 to be picked up (e.g., a ball). FIG. 7 shows a limited cross section of a multi Kilo-Pin design where two Kilo-Pin devices 20 form the gripping surface of traditional pincers. In this iteration of the design, once at least one pin 15 from each Kilo-Pin device has extended far enough relative to the object to be grabbed, the item 10 can be moved. As shown, each device includes arm 11 attached to base 12 that houses one end of the pins. The arms can move relative to the base as needed to grip a desired item.

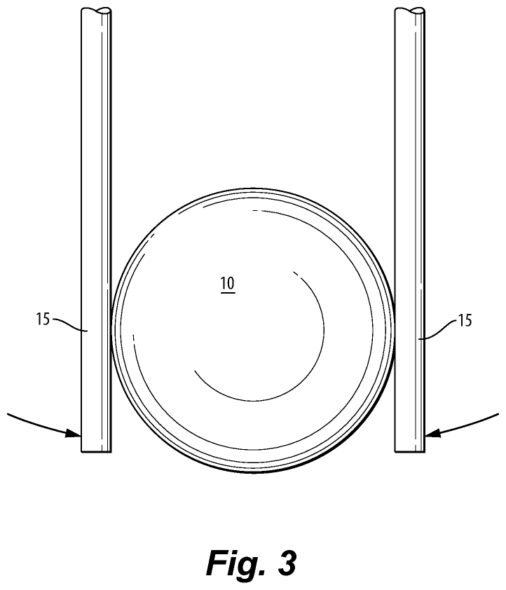

At this point, there are at least three methods for completing the grasping action. First, the pins that are next to or very close to the item 10 and have extended at least far enough to reach the minimum depth for grabbing exert a mechanical force inward towards the item by moving, as shown in FIG. 3. In these embodiments, friction is mainly used to grab the item, with a potential for some angular help. Potentially up to all of the pins attempt to exert a force by moving. Not all pins that move need to move in the direction of the item to be picked up to exert a force on the item. It should be appreciated that FIG. 3 is a very limited cross section of the Kilo-Pin device that only illustrates two of the many pins and a typical ball.

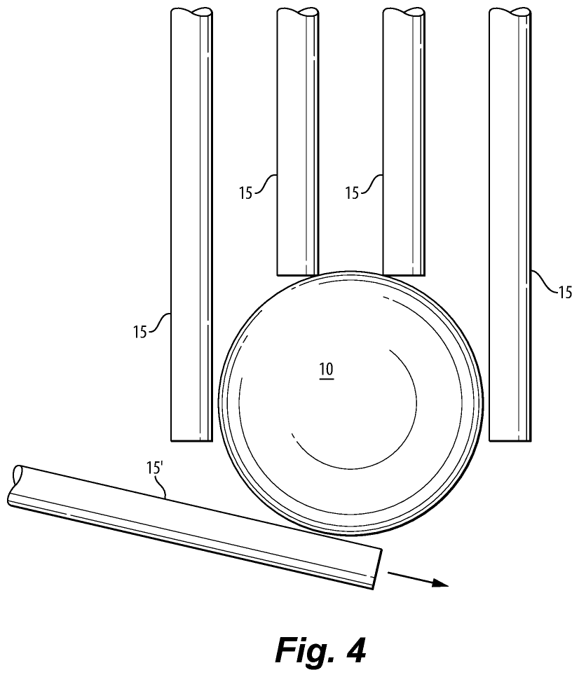

Second, at least one pin 15′ comes in at an angle that is not parallel to the rest of the pins, as shown in FIG. 4. The angled pin slides under or behind the item 10 in such a way that the axis of control that was not achieved by the Kilo-Pin device over the item by the initial pin extension is now achieved. The angled pin can then apply a force towards the item to further secure it. The angled pin can utilize the known item dimensions and the known location of the item relative to the Kilo-Pin device to slide behind/underneath accurately and easily the item to be grabbed, while avoiding the other potential items in its way. Pin 15′ may be straight in some embodiments or curved or not straight in other embodiments. In some embodiments, pin 15′ also may be bendable or configured to curve. It should be appreciated that FIG. 4 is a very limited cross section of the Kilo-Pin device that only depicts a few of the many pins that extend towards the item to be grabbed, a typical item 10, and the pin 15′ that comes in at a non-parallel angle on the other side of the ball.

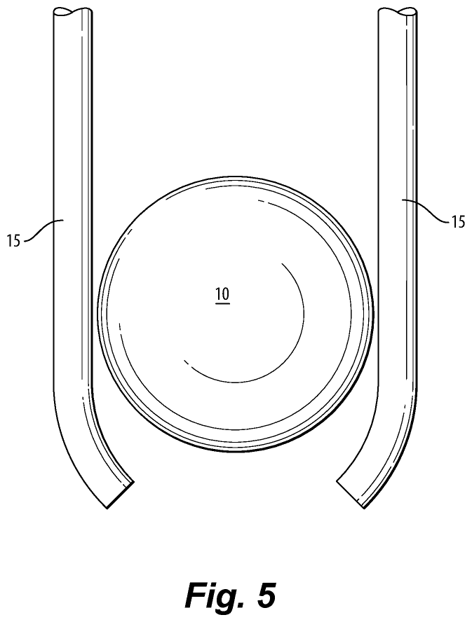

Third, the pins that are next to the item and have achieved at or greater than the minimum depth for grabbing, then bend or curve inwards towards the item 10 creating both a grabbing force against the item and gaining an angular mechanical advantage to restrict the items movement (e.g., grab the item), as shown in FIG. 5. In some embodiments, all of the pins attempt to bend or curve. However, less than all of the pins 15 bend towards the item in some embodiments. Any method can be used to allow the pins to bend, such as (but not limited to) the use of memory metal. “Memory metal” refers to materials that can be bent or deformed (e.g., when contacting an item to be grabbed) and can return to its pre-deformed shape when positioned away from the item to be grabbed. Suitable examples include (but are not limited to) nitinol (equal parts nickel and titanium), copper/aluminum/nickel alloys, and/or alloys of zinc, coper, gold, and iron. It should be appreciated that FIG. 5 is a very limited cross section of the Kilo-Pin device that shows two pins 15′ that bend underneath a typical item (e.g., ball) to help hold it.

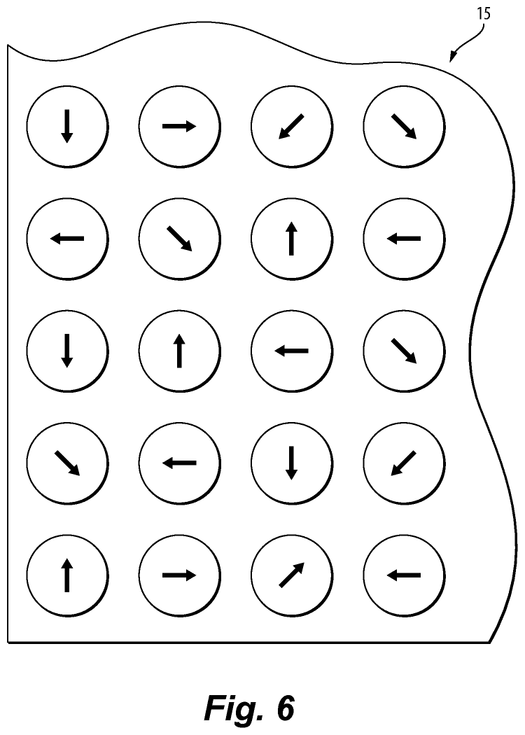

In some embodiments, each pin can press, bend, and/or curve in multiple directions. Alternatively, each pin can press, bend, and/or curve in a limited number of directions (with the minimum being 1). Since there will be many pins that are close enough to item 10, even if less than all of the pins close enough to the item to be grabbed are able to press, bend, or curve towards the item being grabbed, there are still enough pins for the item to be picked up. FIG. 6 illustrates a top view of the pins in a Kilo-Pin device (the direction that the viewer is looking is parallel to the direction the pins are facing) and their random or strategic variety of directions that they can press bend or curve. It should be appreciated that FIG. 6 is a limited top view of the Kilo-Pin device showing the top or cross section of a pin as circles with the arrows indicating the direction that they are capable of bending, curving, and/or pressing.

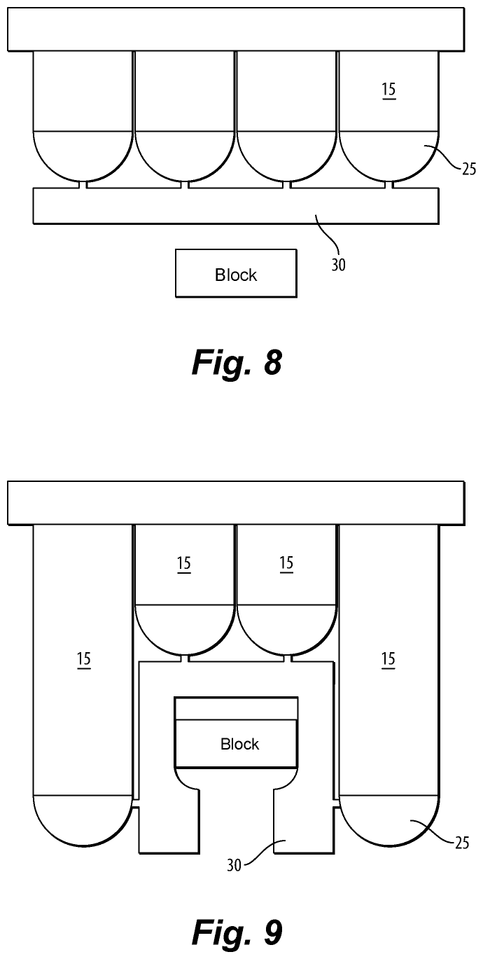

FIGS. 8 and 9 illustrate one embodiment of the disclosed device that allows the system to automatically grip items. As shown, the system includes pins and end cap 25 for the pins that allows the attached sole 30 to rotate around an axis (can be open movement or restricted). Since the arch puts that point of the sole further in by simply rotating, it is inherently providing a gripping force. A larger arch will provide more gripping force per angle of rotation, and a smaller arch will provide less gripping force per angle of rotation. In some embodiments, the sole can be slim and flexible and/or thick and soft (e.g., like foam or a sponge), allowing its compression to provide additional grabbing force onto an object in addition to any grip force from the inherent arch rotation. The sole can be a layer on one side of the pins, as shown.

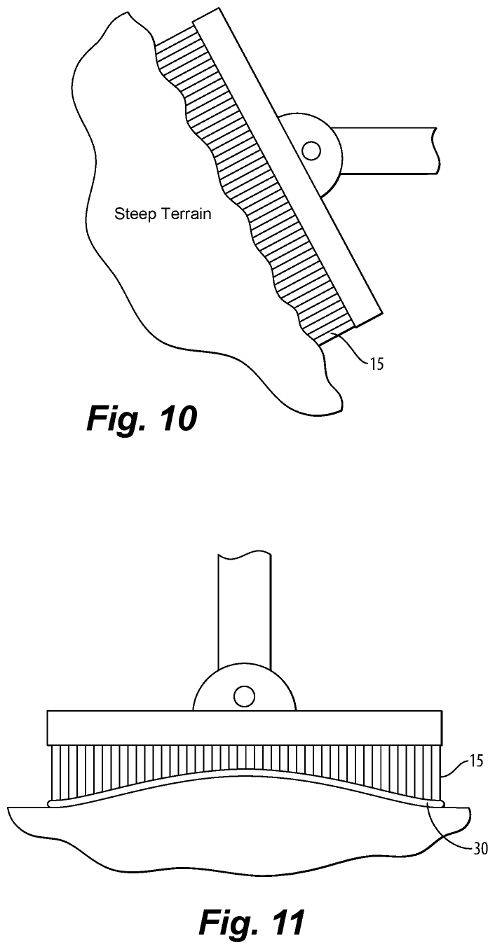

FIG. 10 illustrates one embodiment of using the disclosed system. Specifically, the figure shows an interaction for gripping where the device is used on a steep and/or rocky slope, without sole 30. As shown, the pins extend out and lock into place, providing a large amount of grip on the steep surface. FIG. 11 shows a similar iteration that includes sole 30 in use on a steep and/or rocky terrain (or any terrain), and also being useful on flatter, normal surfaces (like a robot would use for walking).

There are numerous advantages of the Kilo-Pin device over other grabber designs. The majority of the item location detection and grasping motion are very quick, accurate and low tech relative to today's standards. The majority of the grabbing action is done by the same action as the item location mechanism. While a simple digital camera can help identify the general area the Kilo-Pin device should go, it is not necessary, so advanced sensors and/or arrays for analyzing where an item is in a 3d space relative to the grabber are not necessary. High precision for the initial contact with the item is also not necessary.

The Kilo-Pin device can also grab items that are in much tighter spaces than regular pincers, while also creating much more surface area contact between the grabber and the item 10 than other designs on average, increasing the success rate of the item grab. With many of these designs, there are significantly more axis of control contact points in many more directions than other existing designs.

Once the item is grabbed, and presumably moved to the desired location, the Kilo-Pin device releases the item, and the Kilo-Pin device moves on to the next task. To release the item, the different designs have slightly different methods, but they are all similar.

1) The pins that were applying the appropriate force to the item cease applying that force, releasing the item.

2) The pin that came in at an angle not parallel to the other pins retracts, thus releasing the item.

3) The pins that curved, straighten back out, releasing the item.

As described above, although several embodiments of the present invention have been described for illustrative purposes, those skilled in the art will appreciate that various modifications, additions, and substitutions are possible without departing from the scope and spirit of the invention as disclosed in the accompanying claims.

What is claimed is:

1. A device comprising multiple pins that exert a physical force to grab an item.

2. A device for grabbing an item, the device comprising:
an arm that can be moved relative to a base;
wherein the base comprises an array of pins configured to extend a length away from the base to contact the item to be grabbed;
wherein once the pins contact the item to be grabbed, they cease extending away from the base; and
wherein at least one axis of movement for the item is controlled by the device; and
wherein more than one pin is configured to extend further than a minimum axis to contact the item.

3. The device of claim 2, comprising at least 2 pins.

4. The device of claim 2, comprising about 15-500 pins.

5. The device of claim 2, wherein the pins are flexible.

6. The device of claim 2, wherein all of the pins are parallel relative to each other.

7. The device of claim 2, wherein at least one pin is angled relative to at least one other pin.

8. The device of claim 2, wherein the pins are configured to move toward and away from the item to be grabbed.

9. The device of claim 2, wherein each pin is configured to press, bend, curve, or combinations thereof in one or more directions.

10. The device of claim 2, wherein the arm, base or both the arm and base are configured to move toward or away from the item to be grabbed while the pins remain stationary.

11. The device of claim 2, further configured to locate the item by measuring a depth of at least one pin to create a 3D field and analyzing a depth measure using hardware or software.

12. The device of claim 2, configured to use a database of information related to size, shape, and weight of the item to be picked up to allow the device to find and grasp the item.

13. The device of claim 2, further comprising an end cap that allows an attached sole to rotate around an axis, thereby providing a gripping force.

14. The device of claim 13, wherein the sole comprise foam or a sponge comprising compression that provides grabbing force and a gripping force.

15. The device of claim 13, wherein a larger arch provides more gripping force per angle of rotation, and a smaller arch provides less gripping force per angle of rotation.

16. A method of grabbing an item, the method comprising:
positioning the device of claim 1 adjacent to an item to be grasped;
extending one or more pins toward the item until they contact the item, such that a mechanical force is exerted on the device;
whereby friction is used to grab the item.

17. The method of claim 16, wherein friction and contact by one or more angled pins are used to grab the item.

18. The method of claim 16, wherein the one or more pins bend around an exterior of the item.

19. The method of claim 16, wherein the one or more angled pins slide under or behind the item and apply a force on the item.

20. The method of claim 16, wherein two devices are positioned on either side of an item to be grabbed, such that the pins on each device contact the item.
